(19) United States
(12) Patent Application Publication
(10) Pub. No.: US 2013/0057650 A1
(43) Pub. Date: Mar. 7, 2013

(54) OPTICAL GAGE AND THREE-DIMENSIONAL SURFACE PROFILE MEASUREMENT METHOD

(71) Applicants: Guiju Song, Shanghai (CN); Kevin George Harding, Niskayuna, NY (US); Ming Jia, Shanghai (CN); Bo Yang, Shanghai (CN); Qingying Hu, Bellevue, WA (US); Jianming Zheng, Shanghai (CN); Li Tao, Shanghai (CN)

(72) Inventors: Guiju Song, Shanghai (CN); Kevin George Harding, Niskayuna, NY (US); Ming Jia, Shanghai (CN); Bo Yang, Shanghai (CN); Qingying Hu, Bellevue, WA (US); Jianming Zheng, Shanghai (CN); Li Tao, Shanghai (CN)

(21) Appl. No.: 13/257,268

(22) PCT Filed: Mar. 19, 2009
(86) PCT No.: PCT/US09/37602

§ 371 Date: Mar. 30, 2012

(51) Int. Cl. H04N 13/02; G06K 9/00

(52) U.S. Cl. 348/46; 382/154; 348/E13.074

(57) ABSTRACT

An optical gage (10) with a small field of view for three-dimensional surface profile measurement includes a projector (20) having a light source (22) and projection optics (28, 30, 42) that guide light along a projection light path. An optical grating device (34) is arranged in the projection light path and modifies the projection light distribution to project a structured light pattern (46). A phase shifting apparatus (47) shifts the structured light pattern to at least three positions with desired phase shift on said surface (80) to be measured. A viewer (50) includes viewing optics with a viewing light path that is non-parallel to the projection light path, a light sensing array (58) for sensing images of diffuse reflections of the structured light patterns from said surface, and a camera (57) for recording the images. The optical gage further includes a computer (61) which comprises data input communication with the camera and a processor for modeling the surface being profiled based on surface contour information provided by the images.

### CROSS REFERENCE TO RELATED APPLICATIONS

This is a national stage application under 35 U.S.C. §371(c) of prior-filed, co-pending PCT patent application serial number PCT/US2009/037602, filed on Mar. 19, 2009 which is hereby incorporated by reference in its entirety.

### BACKGROUND OF THE INVENTION

1. Field of the Invention

The field of the invention generally relates to measuring devices and methods, and more particularly to an optical gage and a three-dimensional (3D) surface profile measurement method.

2. Description of the Prior Art

Optical gages may be used for measurement of a surface without contacting the surface. Such an optical gage may include an illumination configuration for projecting a light pattern to the surface to be inspected, and a camera for observing and recording the deformation of the light pattern reflected from the surface. There are continuous needs in the art to improve optical gages to be more accurate, and to allow the use of such optical gages for various forms of measurement.

### BRIEF SUMMARY OF THE INVENTION

An aspect of the invention resides in an optical gage a small field of view for three-dimensional (3D) surface profile measurement. The optical gage includes a projector having a light source and projection optics that guide light from the light source along a projection light path. An optical grating device is arranged in the projection light path and modifies the projection light path to project a structured light pattern. A phase shifting apparatus shifts the structured light pattern to at least three positions with desired phase shift of said pattern on said surface to be measured. A viewer includes viewing optics with a viewing light path that is non-parallel to the projection light path, a light sensing array in the viewing light path for sensing images of diffuse reflections of the structured light patterns from said surface, and a camera in the viewing light path for recording the images. The optical gage further includes a computer which comprises data input communication with the camera and a processor for modeling the surface being profiled based on surface contour information provided by the images.

Another aspect of the invention resides in a three-dimensional surface profile measurement method for measuring small features on a surface. The method includes projecting a structured light pattern, shifting the structured light pattern to at least three positions with desired phase shift on said surface to be measured, recording at least three images reflected from said surface according to the at least three structured light patterns; and three-dimensionally profiling said surface according to said at least three images.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic view of an optical gage in accordance with an exemplary embodiment of the invention;

FIG. 2 illustrates a triangular relationship and the geometry utilized by the optical gage shown in FIG. 1;

FIGS. 3A-3C illustrate an exemplary set of three successive images observed by the optical gage;

FIG. 4 exemplarily illustrates a three-dimensional (3D) mapping of a region of interest on surface to be measured based on the images of FIGS. 3A-3C;

FIG. 5 illustrates a reference plane for evaluation of depth the points in the region of interest on the surface; and

FIG. 6 shows a visual analysis result for the region of interest of the surface in FIG. 5.

### DETAILED DESCRIPTION OF THE INVENTION

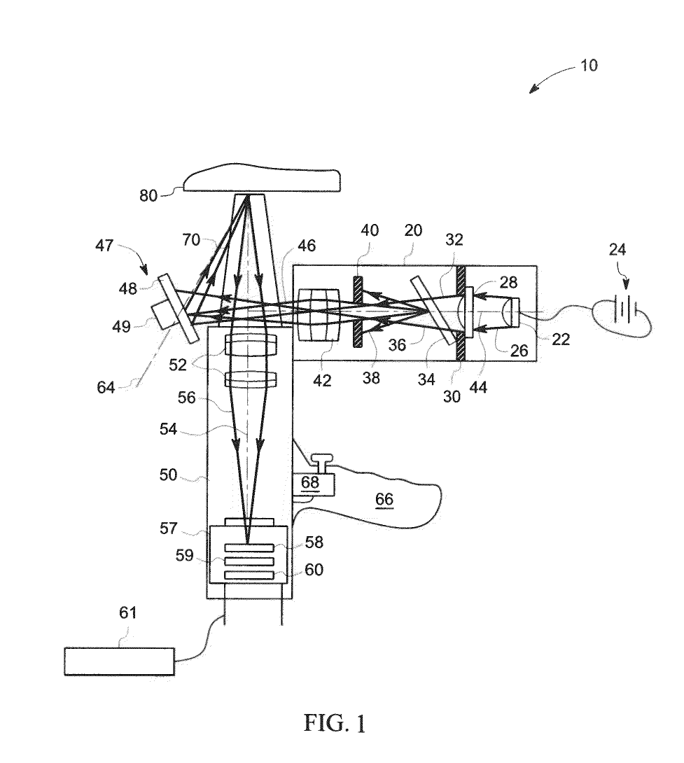

In accordance with an embodiment of the invention, FIG. 1 shows an exemplary hand-held optical gage 10, which has a small field-of-view and is used for three-dimensionally measuring small features, such as corrosion, pitting and the like, on a surface 80, or for measuring an edge. The exemplary optical gage 10 shown in FIG. 1 is a corrosion gage 10. The corrosion gage 10 includes a projector 20 for projecting light beams to a small field of the surface 80 to be measured, and a viewer 50 for observing and recording deformed images reflected from the small field of the surface 80.

The projector 20 has a light source 22, such as a light-emitting diode (LED), with a power source 24, such as a battery or a cord connection to an electrical outlet. The projector 20 comprises an optics system that may include a condenser lens 28 with a condenser aperture 30, and an imaging lens 42 with an imaging aperture 40. A grating 34 of alternating opaque and transparent areas is mounted at or near the focal plane of the imaging lens. A Ronchi ruling grating may be used. Through the grating 34, a structured light pattern 46 is projected onto the surface 80 to be measured. The corrosion gage 10 further includes a phase shifting device 47 for shifting the light pattern 46 to at least three positions with desired shift distances in the location of the pattern as projected onto the surface 80, which will be discussed in greater detail later.

The light source 22 produces diverging beams 26, which are redirected by the condensing lens 28 into converging beams 32. These beams pass through the grating 34, which blocks parts of the beams, resulting in the structured light pattern 46. For example, if a Ronchi grating is used, this results in a projection of planar beams. Light intensity varies on a line normal to these beams and in parallel to the pattern direction as a square waveform with a fundamental sinusoidal component 36 and harmonic components 38 that define the sharp changes in intensity in the square wave. The harmonic components 38 are diffracted by the grating to angles that increase with frequency, and can therefore be removed by the imaging aperture 40. This removes extraneous interference patterns that would otherwise appear on the surface 80 due to crossing harmonics. The imaging aperture 40 may comprise for example a slit parallel to the Ronchi lines.

In certain embodiments, the phase shifting device 47 includes a mirror 48 for redirecting the structured light pattern 46 to the surface 80, and a tilting device 49 for electronically tilting the mirror 48 so as to shifting the structured light pattern 46 to several positions with desired shift distances on the surface 80. The tilting device 49 can be a piezoelectric actuator 49 with a high resolution.

It will also be appreciated by those skilled in the art that the shift in the projected pattern caused by the tilting mirror 48 can be obtained in a number of different manners, including translation of the mirror 48, translation of the grating 34, or by refraction of the light beam using a prism or tilted mirror.

The viewer 50 is attached to the projector 20, and comprises optical lens pair 52 with an optical axis 54 that is nonparallel to the projector optical axis 44. A digital camera element 57 digitizes an image comprising of the diffuse reflection 46 of the structured light pattern from the surface 80 as viewed along a viewing light path 56. The digital camera element 57 may comprise an image sensor 58, such as a charge-coupled device array, an analog-to-digital converter 59, and other electronics as will be known by those skilled in the field of digital cameras. The camera electronics may be connected to an internal battery and memory for storing data for later processing (not shown), or they may be connected to an external computer 61 by wired or wireless means via an interface circuit 60 such as a universal serial bus interface as known in the field of computer input devices. The computer interface circuit may be included in the camera electronics as known in the field of digital cameras.

In the illustrated embodiment, one or more hand grips 66 may be attached to any desired area of the projector 20 and/or viewer 50 for hand-held operation. A trigger button 68 may be provided to trigger a snapshot as known in the field of digital cameras. Acquisition of a digital snapshot may take just a few milliseconds, so substantial stability over a relatively long period of time is not required. In another embodiment (not shown) the gage assembly may be attached to a robotic arm, for automatic operation as known in the field of robotic assembly and inspection. For handheld operation, a guide tip 70 may extend forward of the viewer 50 beside or around the light paths 44, 54 to steady and position the optical gage at a distance from the surface 80 such that the surface is sufficiently proximate the intersection of the optical axes 64, 54 and within a common field of view of the projector 20 and the viewer 50.

The viewer optics 52 may be designed with a field-of-view optimized for looking around an edge of 90 degrees or more. An example of suitable viewer optical specifications for surface corrosion analysis of a turbine component may be as follows:
Field of view=about 3.5 mm square
Depth of field=2 mm or more with <50% contrast loss
Spatial resolution=0.005 mm or less with <2% distortion
Depth resolution=0.005 mm

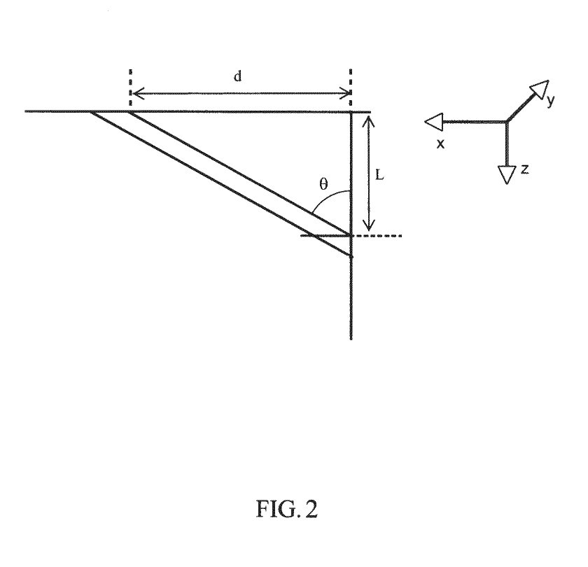

As an exemplary surface profile measurement method of the invention, a uniform light beam emitted from the light source 22 is modulated by the grating 34 into a fringe pattern. The fringe pattern is redirected by the mirror 48 and projects onto the surface 80 to be measured in an illumination path. The projected fringe encodes the object phase information, which is proportional to the surface geometry. In the viewing light path 56, the fringe is imaged onto digital camera element 57 from a different angle than the illumination optical axis 64. Thus the illumination and imaging path constitute a triangle as shown in FIG. 2.

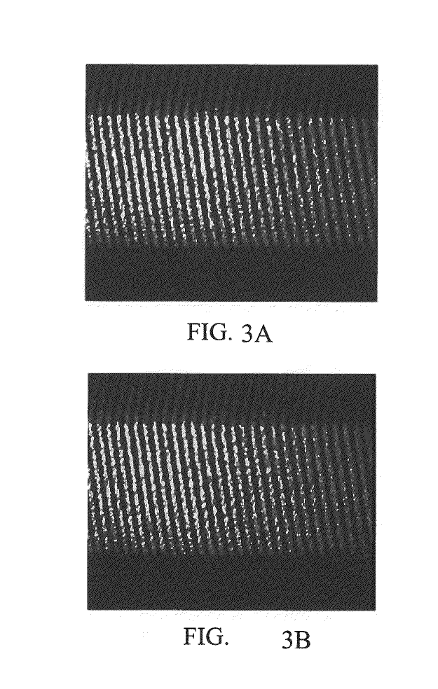

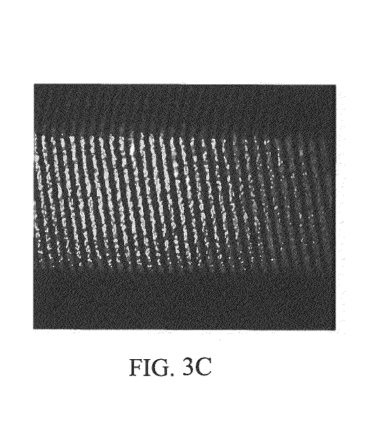

A 3-step phase shifting method is used to extract the phase map from the 2D deformed fringe image so as to compute the surface geometry. In the exemplary measurement method, the piezoelectrical actuator 49 is attached to the redirecting mirror 48 to shift the fringe with ⅓ and ⅔ of the fringe period sequentially. Three images can be captured and shown in FIGS. 3A-3C. Therefore, using this three step shifting method, a phase φ at pixel (i,j) can be calculated as:

$$ϕ ( x , y ) = arctan [ \sqrt{3} \frac{{I}_{1} - {I}_{2}}{2 {I}_{2} - {I}_{1} - {I}_{2}} ]$$

Wherein I₁, I₂, I₃ respectively represent a pixel intensity of the three images. A 3D coordinate of measured surface 80 is expressed as:

$$X = \frac{x}{size x} FOV - {C}_{x \\}$$

$$Y = \frac{y}{size y} FOV - Cy$$

$$Z = Keff a ( x , y )$$

wherein size x and size y are the pixel numbers of the digital camera element 57 along X and Y dimension, respectively. The FOV is the calibrated field-of-view of the system. Cx and Cy are the initial coordinates. The axial distance is proportional to the phase value with the slope of the effective wave number. From the triangular relation and the geometry on FIG. 2, the effective wave number is reduced to be equal to −L/(2πfd), wherein L is a distance between the reference plane and the detector and d is a lateral distance between the detector and the projection path. By such a method, the 3D position of each pixel is calculated and thus a 3D point cloud of region of interest on the surface 80, i.e. a 3D mapping of the surface geometry, is determined and can be observed as illustrated in FIG. 4.

Utilization of the phase shifting device 47 greatly increase the resolution of the small field-of-view corrosion gage 10. In other embodiments, other phase-shifting algorithms like a four-step algorithm, five-step algorithm, 3+3 algorithm, or double three-step algorithm can be used for the 3D profile mapping.

It will be appreciated by those skilled in the art that either or both the projector and the viewer optics could include a telecentric lens system or other optical system configured to improve the uniformity of the light or image field and/or to improve the optical access to the edge surfaces. As will be appreciated by those in the art, a telecentric lens system makes all views to the surface substantially parallel. In the case of the viewer, this would provide a more uniform collection of light from the two sides of the edge break. It will also be appreciated by those skilled in the art that the shift in the projected pattern caused by the tilting mirror can be obtained in a number of different manners, including translation of the mirror, translation of the grating, or by refraction of the light beam using a prism or tilted mirror.

The surface 80 being profiled may be oriented at an angle that is essentially normal to the viewing system optical axis and away from the specular reflection from the illumination system, so as to view the diffusely reflected light without interference from any specularly reflected light. However, the exact orientation of the angle of view is non-critical to the operation of the device.

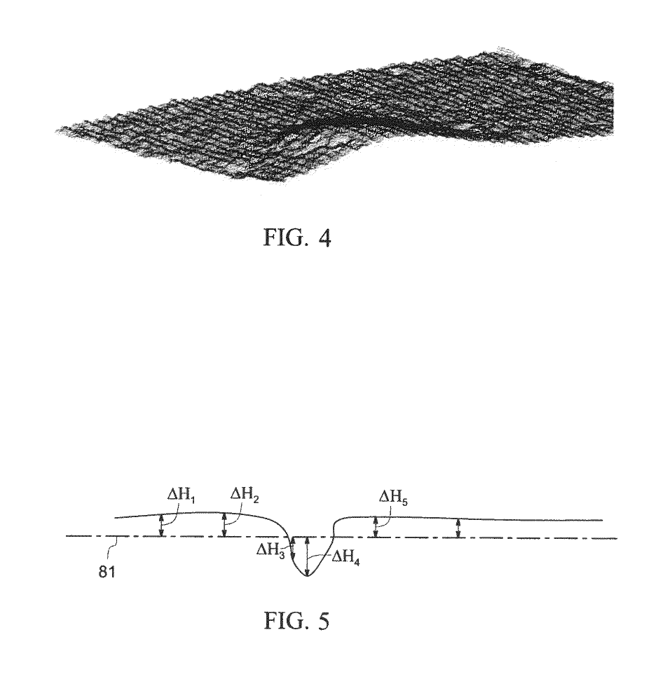

A software system for analyzing the 3D point cloud in FIG. 4 is developed. Referring to FIG. 5, a reference plane 81 for the 3D point cloud of the region of interest is fitted using, for example, Damped Least algorithm. Each point of the reference plane 81 is subjected to the following equation:

AX+BY+CZ+D=0

Using this equation, each point of the 3D point cloud is compared with the corresponding point on the reference plane 81 to calculate a corresponding depth ΔHi (i=1, 2, 3, 4 . . . ).

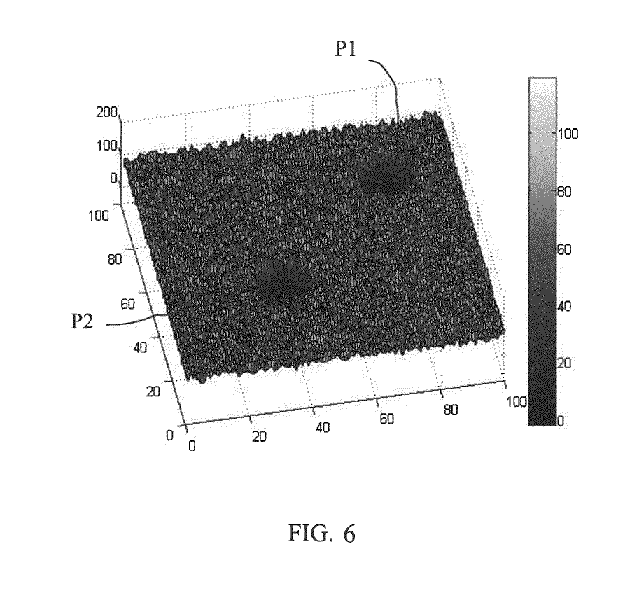

A depth threshold is determined by an operator, and the depth ΔHi for each point is compared to the depth threshold. If the ΔHi is bigger than the threshold value, the corresponding point is treated as a pit point. All the pit points connect with each other and form a corrosion clustering domain. A clustering domain searching algorithm is adopted to auto-searching all the pit areas in the region of interest. As shown in FIG. 6, pits P1 and P2 are defined and visualized with a computer display.

By such a software system and measurement method, different detection parameters for evaluating the corrosion status of the region of interest on the surface 80 can be calculated. For example, P-Depth which is a peak depth of the selected surface; Pit Number, which is the number of corrosion clustering domain; Pits/Area which is the pit number in unit area, and corrosion coverage ratio which is a ratio of the corrosion area to the region of interest are all easy to obtained.

As illustrated in FIG. 1, the grating 34 may be positioned at an angle to the projection optical axis 44 to provide a focal plane of the grating image that crosses the surface 80 at an average depth on the area being profiled, taking the above surface orientation into account. The surface 80 being profiled may be preferably oriented such that lines of the light pattern cross the edge, rather than follow it. However, the pattern contours need not be normal to an edge line for satisfactory operation.

Aspects of the present invention can also be embodied as computer readable code on a computer readable medium. The computer readable medium may be any data storage device that can store data, which thereafter can be read by a computer system. Examples of computer readable medium include read-only memory, random-access memory, CD-ROMs, DVDs, magnetic tape, optical data storage devices. The computer readable medium can also be distributed over network coupled computer systems so that the computer readable code is stored and executed in a distributed fashion.

Based on the foregoing specification, aspects of the present invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the embodiments of the present invention. The computer readable media may be, for example, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

An apparatus for making, using or selling the embodiments of the present invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody the invention as set forth in the claims.

User input may be received from the keyboard, mouse, pen, voice, touch screen, or any other means by which a human can input data to a computer, including through other programs such as application programs.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims. While only certain features of the invention have been illustrated and described herein, many modifications and changes will occur to those skilled in the art. It is, therefore, to be understood that the appended claims are intended to cover all such modifications and changes as fall within the true spirit of the invention.

1. An optical gage with a small field of view for three-dimensional (3D) surface profile measurement, comprising:
a projector comprising a light source and projection optics that guide light from the light source along a projection light path;
an optical grating device in the projection light path that modifies the projection light distribution to project a structured light pattern;
a phase shifting apparatus for shifting the structured light pattern to at least three positions with desired phase shift of said pattern on said surface to be measured;
a viewer comprising viewing optics with a viewing light path that is non-parallel to the projection light path, a light sensing array in the viewing light path for sensing images of diffuse reflections of the structured light patterns from a small field on said surface, and a camera in the viewing light path for recording the images; and
a computer comprising data input communication with the camera and a processor for modeling the surface being profiled based on surface contour information provided by the images.

2. The optical gage according to claim 1, wherein the phase shifting device has a mirror in the projection light path for redirecting the structured light pattern to the surface to be measured, and a tilting device for turning the mirror so as to shift the structured light pattern to at least three positions with desired phase shift distances on said surface to be measured.

3. The optical gage according to claim 2, wherein the tilting device is a piezoelectric mechanical device.

4. The optical gage according to claim 1, wherein the phase shifting device has a mirror in the projection light path for reflecting the structured light pattern to a surface to be measured, and a translation device for translation the mirror so as to shift the structured light pattern to at least three positions with desired phase shift distances on said surface to be measured.

5. The optical gage according to claim 1, wherein the phase shifting device has a mirror in the projection light path for refracting the structured light pattern to a surface to be measured, and a tilting device for tilting the mirror so as to shift the structured light pattern to at least three positions with desired phase shift distances on said surface to be measured.

6. The optical gage according to claim 1, wherein the phase shifting device has a translation device for translating the grating so as to shift the structured light pattern to at least three positions with desired phase shifts on said surface to be measured.

7. The optical gage according to claim 1, wherein the viewing light path is perpendicular to the projection light path.

8. The optical gage according to claim 1, wherein the viewing optics comprises a telecentric lens system.

9. The optical gage according to claim 1 further including a hand-held unit housing the projector, the phase shifting apparatus and the viewer.

10. The optical gage according to claim 1, wherein the optical grating device is a Ronchi grating, the Ronchi grating modifying the projection light pattern into patterned planar beams.

11. The optical gage according to claim 1 being used for corrosion or pitting measurement of the surface, or for measurement of an edge of a surface.

12. A three-dimensional surface profile measurement method for measuring small features on a surface, comprising:
projecting a structured light pattern;
shifting the structured light pattern to at least three positions with desired phase shift on said surface to be measured;
recording at least three images reflected from said surface according to the at least three structured light patterns; and
three-dimensionally profiling said surface according to said at least three images.

13. The three-dimensional surface profile measurement method according to claim 12, wherein projecting a structured light pattern includes projecting a light pattern from a light source, and modulating the light pattern into the structured light pattern with fringes by means of a grating.

14. The three-dimensional surface profile measurement method according to claim 12, wherein shifting the structured light pattern to at least three positions with desired phase shift on said surface to be measured includes shifting the structured light to three positions, each of which is exactly one third of the fringe period at a time.

15. The three-dimensional surface profile measurement method according to claim 14, further including producing a 3D point cloud of a region of interest on the surface by the three images obtained.

16. The three-dimensional surface profile measurement method according to claim 15, further including fitting a reference plane for said 3D point cloud, each point of the 3D point cloud being compared to a corresponding point of the 3D point cloud so as to calculate a corresponding depth of the points.

17. The three-dimensional surface profile measurement method according to claim 16, further including determining a depth threshold.

18. The three-dimensional surface profile measurement method according to claim 17, further comprising comparing the depth of the points with the depth threshold and determining pits by auto-searching corrosion clustering domains.
